(19) United States
(12) Patent Application Publication
(10) Pub. No.: US 2002/0096497 A1
(43) Pub. Date: Jul. 25, 2002

(54) Continuous wire EDM for forming blind holes

(76) Inventor: George V. Jariabek, Encino, CA (US)

Correspondence Address: Bruce A. Jagger, BRUNTON & JAGGER, P.O. Box 29000, Glendale, CA, 91203, US

(21) Appl. No.: 10/046,425

(22) Filed: Jan. 10, 2002

Related U.S. Application Data
(60) Provisional application No. 60/263,878, filed on Jan. 23, 2001.

(51) Int. Cl. B23H 7/02

(52) U.S. Cl. 219/69.12

(57) ABSTRACT

A continuous wire EDM machine is configured to form blind holes by using a track member to carry the EDM wire into the cut. The track member has a thickness that is less than the diameter of the EDM wire. The EDM wire is retained, for example, in a shallow groove formed in the arcuate outer peripheral edge of the thin planar track member. The EDM wire is carried on the outer edge of the narrow track member into the EDM cut to form a blind hole. The EDM wire is received in the shallow groove to a depth that is less than the radius of the EDM wire. The EDM wire can be advanced into a workpiece to a depth that is slightly less than the depth at which a spark forms between the workpiece and the broader base of the track support member that supports the thin track member. The radial length of the track member is measured in a direction generally normal to the longitudinal axis of the EDM wire and to the thickness of the track member. The track member can be on a rotatably mounted cutting wheel so that the wire is carried through a cutting zone, or on a stationary guide where the wire slides axially along the periphery of the track member through the cutting zone. The precision of the EDM formed cut in the workpiece is maintained by advancing the EDM wire along its longitudinal axis so that it is renewed in the cutting zone. Very thin track members in the order of a few thousandths of an inch thick and up to one-half inch long can be used. The length of the track member determines the depth to which it can carry the EDM wire into the cut. In, for example, a cutting wheel, the length is approximately the radial length of the track member.

### BACKGROUND OF THE INVENTION

1. Field of the Invention

The invention relates in general to continuous wire EDM machines that are capable of forming blind holes, and, in particular, to such machines wherein a specially formed guide for an EDM wire permits the formation of blind holes.

2. Description of the Prior Art

Continuous wire EDM machines are well known. In general such machines comprise a special EDM wire that is stretched between two guides. The EDM wire extends completely through the workpiece. As the wire and the workpiece are brought into close proximity an arc is struck. The wire and workpiece are moved relative to one another so that the straight wire advances through the workpiece. As the wire is consumed it is slowly moved past the workpiece so that a fresh piece of wire is continuously presented to the workpiece as cutting proceeds. The workpiece is generally immersed in a cutting fluid such as, for example, deionized water. One advantage of a continuous wire EDM process is that the electrode is automatically and continuously replenished as it is consumed. The cut is thus maintained at a predetermined size. A substantial disadvantage of the conventional continuous wire EDM process is that it can not be employed to form a blind hole.

EDM machines are also well known where an electrode of finite length is advanced into a workpiece to form a blind hole. This is sometimes referred to as “Sinker” EDM technology. The electrodes can be of any desired cross-sectional configuration, including, for example, round, square, rectangular, hollow, or the like. The cross-section of a hole formed by this sinker EDM technology is generally substantially the same as that of the electrode. In general, the efficient operation of sinker electrodes requires that the electrode be mounted for automatically controlled reciprocal movement relative to the workpiece. The formation of a slot with sinker EDM technology generally requires that the cross-section of the electrode be the same as the cross-sectional shape of the slot. There are practical limits to how long a thin blade like electrode can be and still retain its accuracy. This substantially limits the length of the slots that can be formed with sinker electrodes.

These and other difficulties of the prior art have been overcome according to the present invention.

### BRIEF SUMMARY OF THE INVENTION

A preferred embodiment of the continuous wire EDM machine and process according to the present invention comprises a wire guide structure that permits continuous wire EDM machines to form blind holes. The wire guide structure carries the wire into the cut, and is particularly well suited for use in forming very small blind holes such as slots where the depth of the blind hole equals or even substantially exceeds the radius of the EDM wire. The depth of the blind slot can vary, for example, from a light mark on a surface of a workpiece to a cut that exceeds the radius of the wire by a factor of 2, or 10, or 50, or even more.

A hole is said to be blind when it does not extend entirely through the workpiece in any direction. A blind hole cannot be formed by a wire that extends in a straight line entirely across a flat workpiece and intersects two of its edges. For example, a groove or slot that extends entirely across a flat workpiece and intersects two edges is not a blind hole. Such a groove can, however, be a blind hole while it is in the process of being formed if the formative EDM wire does not extend entirely across the workpiece. Thus, a uniform slot that is several feet long, and extends entirely across a workpiece, can be formed, according to the present invention, one short blind hole at a time. There is a limit as to how far a small diameter EDM wire, for example, 0.008 inches or less in diameter, can extend unsupported in a workpiece without breaking or wandering from the intended cut. The ability to form thin deep holes that are several feet in length by making a series of short accurate blind holes is a significant feature of the present invention. A groove that extends at a substantially constant depth from one edge only part way across such a workpiece is generally a blind hole, and it can not be formed by a wire that extends entirely across the workpiece. A groove that does not intersect any edge of flat a workpiece is a blind hole. support

Where, for example, very narrow blind slots in the order, for example, of approximately 0.005 to 0.010 inches wide and approximately 0.5 inches or more deep are to be formed in a workpiece, the guide, according to the present invention, preferably comprises a track support member with a very narrow wire guiding track member projecting radially outwardly from its periphery. The thickness of the planar wire guiding track in the axial direction is less than the diameter of the generally cylindrical EDM wire, yet it serves to hold the wire away from the periphery of the wider track support member by a distance that is preferably at least 0.001 inches greater than the depth of the blind hole that is to be formed in the workpiece. The EDM wire is carried into the cut by the track member. The outer periphery of the track generally includes a wire retention element, which includes a generally concave shape so as to retain the wire on the track, and can include other wire retention features.

The aspect ratio of the planar wire guiding track is preferably greater than 1 to 1, that is, the radial length of the track is greater than its thickness in the axial direction. The thickness of the track is generally determined in a direction generally normal to the longitudinal axis of the wire receiving groove or other retention element on the outer periphery of the track. The radial length of the track is generally measured in a direction that is generally normal to both the longitudinal axis of the EDM wire and the longitudinal axis of the groove that receives it. In general, where the wire and the guide are engaged, the guide is preferably arcuate. The use of the term “radial” is used in this context, and is not intended to necessarily imply that the guide is circular. The aspect ratio of the track is selected so as to provide a blind hole with the desired depth and width. In some circumstances, the aspect ratio of the track can be as much as 100 to 1, or even more, and the advantages of the present invention are particularly apparent when the aspect ration is at least about 2 to 1, or more. The depth of the cut formed according to the present invention is generally at least equal to the radius, and preferably to the diameter of the EDM wire. The advantages of the present advantage are most evident when the depth of the cut is preferably equal to at least about twice the diameter of the EDM wire. The aspect ratio of the cut is generally approximately equal to the aspect ratio of the track, that is, a track with an aspect ratio of 5 to 1 (length to width) is generally capable of producing a cut with an aspect ratio of approximately 5 to 1 (depth to width). The absolute dimensions of the cut will, of course, be larger than those of the track. Where the aspect ratio is so high that the structural strength or rigidity of the planar track element becomes an issue, the guide member can be constructed from special high strength materials such as metallic carbides, or the like. Typically, the continuous EDM wire is carried by or drawn over the outer periphery of the guide. The motion of the wire can be continuous or intermittent as may be required to compensate for its erosion by sparks in the cut. The dimensions of the wire should be maintained by renewing the wire in the cut as needed. This maintains the dimensions of the cut within the desired tolerances.

The EDM wire is trained around a part of the guide member, for example, a wheel, and held in place on the wire guiding track by a shallow peripheral annular groove that is located on and circumscribes the outer periphery of the track. The wire only contacts the guide for a part of the circumference of the guide. The longitudinal axis of the groove generally parallels that of the EDM wire where they are engaged. Where the guide is in the form of a circular wheel, the peripheral annular groove is generally concentric with the axis of rotation of the circular wheel. For very thin high aspect ratio tracks it is generally not possible to form them with conventional machining operations. The machining forces generally distort the track when it is, for example, less than 0.005 inches thick in the axial direction and greater than 0.010 inches long in the radial direction. Exotic machining operations such as, for example, laser cutting operations are not universally available, and not suitable for use with all materials and configurations.

A preferred method of forming a wire guiding track on the periphery of a electrically conductive circular wheel according to the present invention comprises selecting a wheel and machining a blank track on the outer periphery of that wheel. The blank track preferably has a radial length greater than the depth of the cut that is intended to be formed using it. The aspect of the EDM cut which is to be made should be at least 1 to 1 and is preferably at least about 2 to 1 (depth to width). An annular groove is formed in the radially outer periphery of the blank track. The bottom of the groove is generally centered with respect to the axial thickness of the blank track. That is, the bottom of the groove is preferably, but not necessarily, located half way between the opposed radially extending sides of the blank track. The configuration of the annular groove in the periphery of the blank track is preferably such that it serves to center an EDM wire with respect to the opposed, radially extending sides of the blank track. Typically, an annular groove with a generally “V” shaped cross section is preferred. Other cross-sectional configurations such as rectangular or arcuate, or the like, can be employed if desired. In general, the initial axial thickness of the blank track is greater than the diameter of the EDM wire with which it is to be used. This permits the groove to be formed in the blank with conventional machining operations. The EDM wire is trained around a portion of the wheel and restrained in the annular groove. A scrap workpiece is selected. Typically, a fine grained graphite block serves well as such a scrap workpiece. The scrap workpiece is selected so a controlled cut can be achieved. It is scrap in the sense that it is sacrificed to produce the tool, but not in the sense that it is an inferior or rejected piece of material. Indeed, where very thin tracks are to be formed, the scrap workpiece must be carefully selected so that the spark will be consistent during the machining of the blank.

The EDM machining process on the scrap workpiece is commenced with the EDM wire mounted in the annular groove in the blank track. The portion of the guide that is engaged with the continuous EDM wire forms a cutting zone. The cutting zone is advanced towards the scrap workpiece until a spark is generated between the cutting zone and the scrap workpiece. As the EDM machining proceeds, the radially opposed sides of the blank track are eroded away within a few minutes until the axial thickness of the track is less than the diameter of the uneroded EDM wire. The thickness of the track in the axial direction is determined by the amount of erosion that is allowed to take place. Some erosion occurs on the radial sides because conductive particles are generally present in the gap between the workpiece and the radial sides. Initially, the blank track will be eroded to an axial thickness that is about the same as the diameter of the wire. Some further erosion of the radially opposed sides of the track takes place because of the loose particles in the gap between the track and the wall of the cut. This erosion is allowed to continue until the axial thickness of the track is somewhat less than the diameter of the wire. The erosion substantially ceases because the gap between the walls of the track and the walls of the cut is greater than the active spark gap between the continuously renewed EDM wire and the generally semicircular area surrounding the wire at the bottom of the cut. Since the diameter of the continuously renewed wire is greater than the width of the eroded track, the gap between the walls of the cut and the wire is less than that between the walls of the cut and the walls of the track. The spark will preferentially form in the shorter gap where there is less resistance. The erosion of the radial sides during the formation of the track is promoted by using a spark that is stronger than that to which the track will be subjected in its intended use. The thickness of the track is preferably such that during its intended use substantially all of the erosion in an EDM cut will take place between the wire and the workpiece, and not between the workpiece and the opposed radially extending sides of the track. At a normal rate of continuous wire feed (a few inches to a foot or more per minute), the width of the EDM cut will be determined almost entirely by the diameter of the cylindrical EDM wire. The dimensions of the entire EDM cut are thus maintained within the desired tolerances. When the track becomes worn or damaged, a new track is quickly and easily formed using the same procedure.

During use the tension in the wire must be carefully controlled. A uniform predetermined tension and wire feed rate produces a steady efficient burn where the wire is not significantly stretched, and the wire dose not drop out of the shallow groove in which it is received. When a wire is dropped during the formation of a cut, the groove is usually damaged so that it must be reformed.

The thin track, particularly when it is below approximately 0.008 inches in axial thickness is so fragile that it requires careful control of the tension and other wire control parameters to avoid damaging the track. Too much tension will distort the thin track. Not enough tension will cause the wire to slip out of the shallow annular groove on the track. More than one-half and generally an amount of wire equal to from approximately two-thirds to three-quarters of the diameter of the wire projects radially outwardly of the outermost part of the track. When the EDM wire slips out of the shallow annular groove on the track while EDM cutting is underway, it often damages the groove so that it is no longer usable. The ability to quickly and easily recreate the track using conventional inexpensive machine tools provides significant advantages. In general, a wheel that serves as a blank for the formation of successive tracks of decreasing diameter should be of such an initial diameter that several track blanks can be formed, generally by turning, before the wheel becomes too small in diameter and must be discarded.

The guide member, which is preferably a wheel, can be composed of various materials. The guide member need not be electrically conductive. Non-conductive ceramic wheels, for example, can be employed. Other procedures for forming the tracks besides EDM machining can be employed if necessary or desired. Guide members can be formed by molding or casting. Ceramics, for example, can be formed by molding, grinding or the like. The track element can be formed, for example, of a conductive material while the guide member is composed of non-conductive materials.

Some machining operations are substantially impossible to perform without applying the present invention. For example, slotting a thin tube (0.013 inch inside diameter, 0.020 inch outside diameter, with a substantially constant 0.006 inch wide slot through one wall and extending axially for approximately 4 feet along the tube) constructed of a stainless steel alloy, tungsten carbide, refractory metal, or the like, had generally been considered to be economically impractical at best, and, for the most part, physically impossible. The dimensions of the slot can not be maintained, for example, with an ordinary discontinuous EDM electrode, because the diameter of the electrode is reduced as the cut proceeds, thus reducing the width of the slot. Such slots can be easily formed according to the present invention utilizing, for example, a track with an axial thickness of about 0.003 inches and an EDM wire with an initial as made diameter of about 0.004 inches. Such EDM cutting assemblies can be employed to form slots with a width of, for example, approximately 0.007 inches. EDM wire as thin as about 0.002 inches can be employed to form slots as narrow as about 0.004 to 0.005 inches.

The present invention enjoys utility in embodiments where larger diameter EDM wires are to be employed. For example, EDM wires in excess of 0.020 inches or larger in diameter can be employed if desired.

Guides in configurations other than circular wheels can be employed if desired. For example, a stationary cutting blade having an arcuate shallow groove on an arcuate periphery can be employed, provided the coefficient of friction between the wire and the groove is low enough to avoid breaking or distorting the wire as the wire is pulled through the shallow groove.

The continuous EDM wire is continuously renewed by feeding fresh wire to the cutting zone. The EDM wire is generally advanced into the cutting zone in the direction of its longitudinal axis. The longitudinal axis is located at the center of the wire. The longitudinal axis of the shallow groove in which the EDM wire is received is generally parallel to and offset slightly from the longitudinal axis of the wire. The wire is generally received in the shallow groove to a depth that is less than the radius of the wire, so the longitudinal axis of the shallow groove, measured at the outer edge of the track, is generally offset from the longitudinal axis of the wire towards the body of the track by an amount that is from approximately one-eighth to three-quarters of the radius of the wire.

The nature of the EDM continuous wire systems is such that, except for a reciprocal motion that moves the wire into and away from the workpiece, the wire system is generally, although not necessarily, mounted in one fixed location, and the workpiece is moved relative to that location. The workpiece can be rotated about any of its axes of rotation or translated linearly about any of its axes of rotation while EDM cutting takes place. Intricate and convoluted blind holes can thus be formed in workpieces of almost any configuration.

Cutting systems according to the present invention can be ganged together with one another in series or parallel or with other forms of EDM machining so as to perform multiple cutting operations of different characteristics at one time. Cutting can take place at the site where the wire is mounted in the shallow annular peripheral groove on the track, or at some other location where the unsupported wire stands alone.

Conventional EDM wire, EDM machines, and EDM controls can be applied to control the operation of a machine using tracks of reduced thickness according to the present invention.

Other objects, advantages, and novel features of the present invention will become apparent from the following detailed description of the invention when considered in conjunction with the accompanying drawings.

### BRIEF DESCRIPTION OF THE DRAWINGS

The present invention provides its benefits across a broad spectrum of continuous wire EDM operations. While the description which follows hereinafter is meant to be representative of a number of such applications, it is not exhaustive. As those skilled in the art will recognize, the basic methods and apparatus taught herein can be readily adapted to many uses. It is applicant's intent that this specification and the claims appended hereto be accorded a breadth in keeping with the scope and spirit of the invention being disclosed despite what might appear to be limiting language imposed by the requirements of referring to the specific examples disclosed.

Referring particularly to the drawings for the purposes of illustration only and not limitation:

FIG. 1 is a schematic side elevational view of a preferred embodiment of the invention showing a preferred embodiment applied to the slotting of a tube.

FIG. 2 is a cross-sectional view of a cutting wheel with a continuous wire EDM electrode mounted in an annular wire retention element on a wire guide structure according to the present invention.

FIG. 3 is a cross-sectional view taken along line 3-3 in FIG. 1, laterally across the width of a cylindrical tube workpiece with a guide-wire assembly of the present invention in position to form a slot in the wall of the tube.

FIG. 4 is a cross-sectional view of a cutting wheel according to the present invention with a blank track on its periphery, and an EDM wire received in an annular groove on the periphery of the blank track.

FIG. 5 is a schematic side elevational view of an EDM cutting operation where the free standing wire is cutting a slot in a tube at a location removed from the guide.

FIG. 6 is a diagrammatic side elevational representation of a workpiece in operative association with an EDM cutting station according to the present invention wherein the axes of the workpiece are shown so as to illustrate the relative movement that is permitted between the workpiece and the cutting assembly.

FIG. 7 is an elevational view partially in cross-section taken along line 7-7 in FIG. 8, illustrating a set of ganged EDM cutting assemblies.

FIG. 8 is a diagrammatic view of ganged EDM cutting assemblies in which, for purposes of clarity, the workpiece is not shown.

FIG. 9 is a diagrammatic side elevational view of a preferred form of a table for holding a small elongated workpiece for slotting.

FIG. 10 is a diagrammatic plan view of the table shown in FIG. 9.

FIG. 11 is a side elevational view taken along line 11-11 in FIG. 10.

FIG. 12 is a plan view of a workpiece.

FIG. 13 is a cross-sectional view taken along line 13-13 in FIG. 12.

FIG. 14 is a plan view similar to FIG. 12 showing a partially completed blind hole cut in the workpiece.

FIG. 15 is a cross-sectional view taken along line 15-15 in FIG. 14.

FIG. 16 is a diagrammatic side elevational view of a stationary guide member.

FIG. 17 is a diagrammatic cross-sectional view of the final stage in the formation of a track member by EDM machining.

FIG. 18 is a diagrammatic cross-sectional view of a blank guide member and EDM wire assembly prior to the formation of a track on the guide member.

FIG. 19 is a diagrammatic cross-sectional view similar to FIG. 18 illustrating the material that is removed from the blank by EDM machining to form a track.

FIG. 20 is a plan view of a rectangular workpiece, which has an open hole therein.

FIG. 21 is a cross-sectional view taken along line 21-21 in FIG. 20.

FIG. 22 is a plan view of a rectangular workpiece which has a blind hole therein.

FIG. 23 is a cross-sectional view taken along line 22-22 in FIG. 22.

FIG. 24 is a plan view of a cylindrical workpiece which has a blind hole therein.

FIG. 25 is a cross-sectional view taken along line 25-25 in FIG. 24.

FIG. 26 is a diagrammatic side elevational view similar to FIG. 6 illustrating the rotation of a workpiece relative to a cutting wheel to form a bore in the workpiece.

FIG. 27 is a view similar to FIG. 26 illustrating the cutting wheel advanced into a bore in the workpiece.

FIG. 28 is a cross-sectional view taken along line 28-28 in FIG. 29.

FIG. 29 is a plan view of the workpiece illustrated in FIG. 28.

FIG. 30 is a side view of a square cutting wheel.

FIG. 31 is an edge view of the square cutting wheel of FIG. 30.

FIG. 32 is a diagrammatic side view of a stationary cutting blade with a hydrostatic bearing.

FIG. 33 is an edge view of the stationary cutting blade of FIG. 32.

FIG. 34 is a broken cross-sectional view of the outer periphery of a guide member with a very shallow generally circular wire retention element.

FIG. 35 is a broken cross-sectional view of the outer periphery of a guide member illustrating a wire retention element with a flat bottom and rails.

FIG. 36 is a broken cross-sectional view of the outer periphery of a guide member with a deep parabolic shaped wire retention element.

FIG. 37 is similar to FIG. 16 and illustrates an embodiment where an external wire guide is employed.

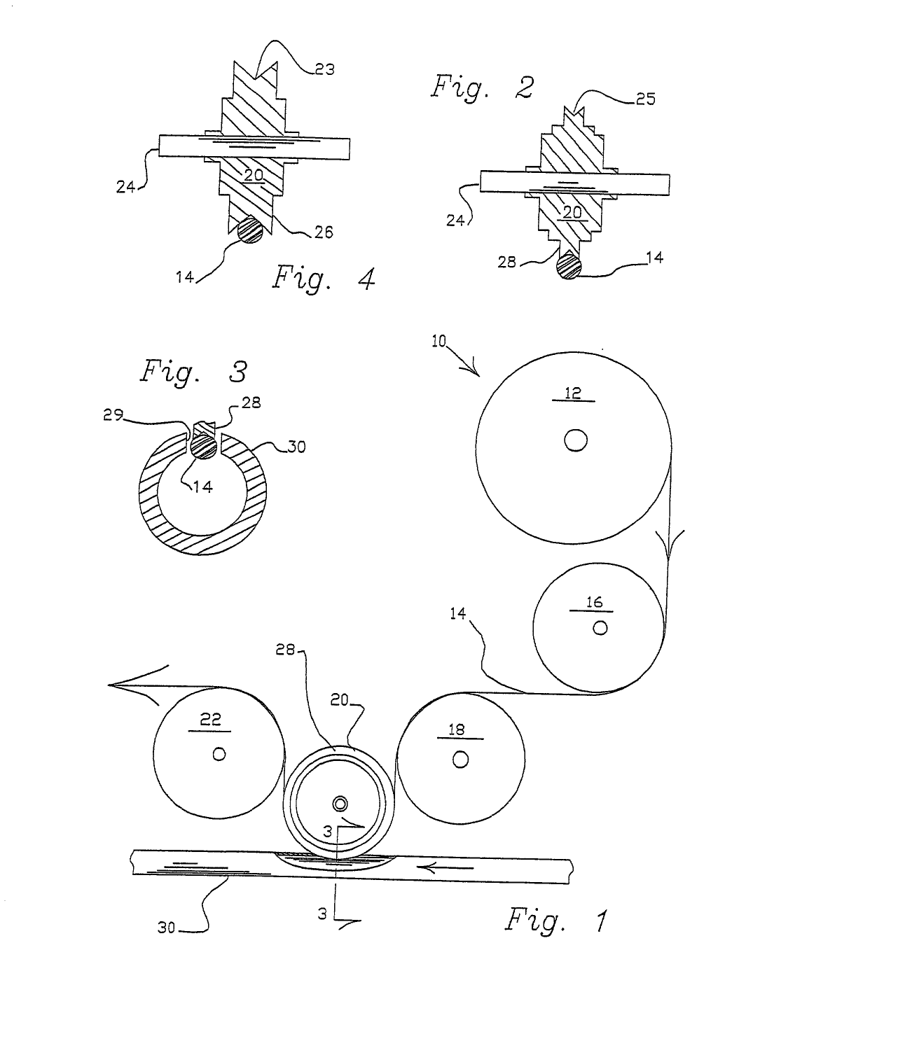

### DETAILED DESCRIPTION OF THE PREFERRED EMBODIMENTS

Referring now to the drawings wherein like reference numerals designate identical or corresponding parts throughout the several views.

Referring particularly to the drawings, there is illustrated generally at 10 an EDM continuous wire cutting assembly that includes a wire guide structure and comprising a spool of EDM wire 12, an EDM wire 14, a guide roller 16, a guide roller 18, a guide roller 22 and a cutting wheel 20. Cutting wheel 20 acts as a rotating track support and includes a ring or annular flange 28 extending radially outwardly from the outer annular periphery of the cutting wheel. The ring 28 acts as a track to guide the wire 14. The cutting wheel 20 can also be considered to be a pulley that guides the EDM wire 14 as it travels in the direction shown by the arrows in FIG. 1. The portion of ring 28 that is instantaneously within the cut acts as a blade that carries or guides the EDM wire into and positions it within the cut. The wire, in the configuration of FIG. 1, engages an annular wire retention element in the form of a groove in the periphery of ring 28 over at least the portion of the cutting wheel 20 that is intended to engage the workpiece. The portion of the periphery of ring 28 together with wire 14 that engages the workpiece 30 forms a cutting zone where the slot 29 is formed. The EDM wire is carried into the slot 29 on the arcuate periphery of the track 28 to a depth sufficient to form the desired slot. The fact that the track 28 is narrower than the diameter of the wire 14 permits the track to carry the wire into the cut to form a blind slot with a depth is greater than the radius of the wire 14. When the aspect ration of the track 28 (radial length to axial width) is greater than approximately 2 to 1, the arcuate periphery of the track can carry the wire into the blind slot for a depth that is greater than about the diameter of the wire. The slot 29 is a blind hole as it is being formed. As the cutting wheel 20 advances relative to the workpiece 30, the cutting action takes place in a blind hole. As is well known in the art, an EDM wire, when electrical current is supplied, serves as a cutting tool. According to the present invention, the EDM wire 14 is guided so as to form the desired blind hole. The guide for the EDM wire 14 preferably does no cutting. Preferably, the conditions during use are less aggressive than those during the formation of the guide, so that there are substantially no cutting sparks formed between the guide and the workpiece.

The assembly 10 is illustrated as being engaged in cutting a longitudinally extending slot in tubular workpiece 30. The aspect ratio of ring 28 is such that the EDM wire 14, at its radially outermost location, is disposed within the hollow core of tubular workpiece 30. That is, the continuous EDM wire 14 has cut entirely through the wall of workpiece 30 so as to form a slot such as that shown at 29 in FIG. 3 in the wall of the workpiece 30. As will be understood by those skilled in the art, the assembly 10 could be controlled to form an axially extending groove in the exterior surface of the workpiece, without cutting entirely through the wall. The wire engages the “V” shaped EDM wire retainer groove 25 at the radially outermost end of the ring or track 28. The tubular workpiece 30 and wire 14 are driven in the directions shown by the arrows in FIG. 1 while cutting wheel 20 remains laterally stationary as it rotates. Generally, the cutting wheel 20 is mounted, in accordance with conventional EDM technology, so that it reciprocates vertically responsive to instantaneous conditions in the EDM cut.

Cutting wheel 20 is illustrated in FIG. 4 with a blank track or ring 26. The axial length of blank track 26 in a direction along the longitudinal axis of axel 24 is greater than the diameter of the generally cylindrical wire 14. Thus, when the cutting wheel 20 is moved towards a scrap workpiece to the point where EDM cutting commences, the wire 14 will make an initial shallow cut that is relatively narrow as compared to the axial thickness of blank track 26. As cutting proceeds cutting will commence between the blank 26 and the scrap workpiece. The width of the cut will be expanded by the action of the blank 26. Concurrently with the expansion of the width of the cut, the blank 26 will itself be eroded. As cutting proceeds further the erosion of the opposed radially extending sides of blank 26 reduces the axial thickness of the blank to an amount equal to about the diameter of the uneroded wire. Because of the presence of debris in the cut on either side of the blank 26, erosion of the axial thickness of the blank continues until it is less that the thickness of the wire. The generally cylindrical wire rests in the resulting shallow retainer groove in the outer periphery of the track, to a depth that is less than its radius. The blank 26 is projected into the scrap workpiece to a depth that is sufficient to form a ring 28 that will provide the depth of cut that is desired in the workpiece with which the completed cutting wheel is intended to be used.

The cutting wheel 20 is journaled for rotation about the longitudinal axis of axel 24. According to conventional wire EDM technology, the cutting wheels are often submerged in dionized water. For this reason, the bearings, of whatever form, should be well sealed.

The cutting assembly, which is generally illustrated at 32 in FIG. 5, includes a continuous EDM wire 34 that is driven between guide rollers 38 and 40 in the direction indicated by the arrows. That is, the wire and the workpiece both move at the same time, but at the same or different rates. The wire 34 is trained around a portion of a ring or track 44 that circumscribes the radially outer periphery of cutting wheel 42. Tubular workpiece 36 is driven axially as illustrated by the associated arrow in FIG. 5. Preferably, the wire and the workpiece move concurrent with one another as shown in FIG. 5. Driving the wire countercurrent to the movement of the workpiece generally tends to dislodge the wire from the guide with some frequency. The wire 34 tends to remain in contact with the workpiece over a longer cutting distance in such a configuration. The ring 44 acts as a blade that carries the wire 34 into the cut. The cutting in the assembly indicated generally at 32 takes place in the elongated region or cutting zone indicated at 46. In region 46 the wire 34 is free standing. The length of the contact between the EDM wire and the workpiece in region 46 is longer than with most guides. There are certain advantages to the longer contact area or cutting zone. The cut is formed more quickly than with, for example, the assembly illustrated in FIG. 1. Also, the cut has a higher finish, that is, it is not as rough. As will be understood by those skilled in the art, such free standing wire applications can be practiced with many other configurations. The initial cut in workpiece 36 is made by the wire on the cutting wheel, but once the cut has been extended entirely through the wall of the tube, the blade or ring 44 carries the wire into the hollow interior of the tubular workpiece 36. Because the wire extends at an angle relative to the workpiece, and the cut extends entirely through the workpiece, the cutting proceeds in freestanding region 46. Because of the axial length of the cut, the depth of the cut is limited by the radial length of the track 44 even though the cutting is occurring in region 46.

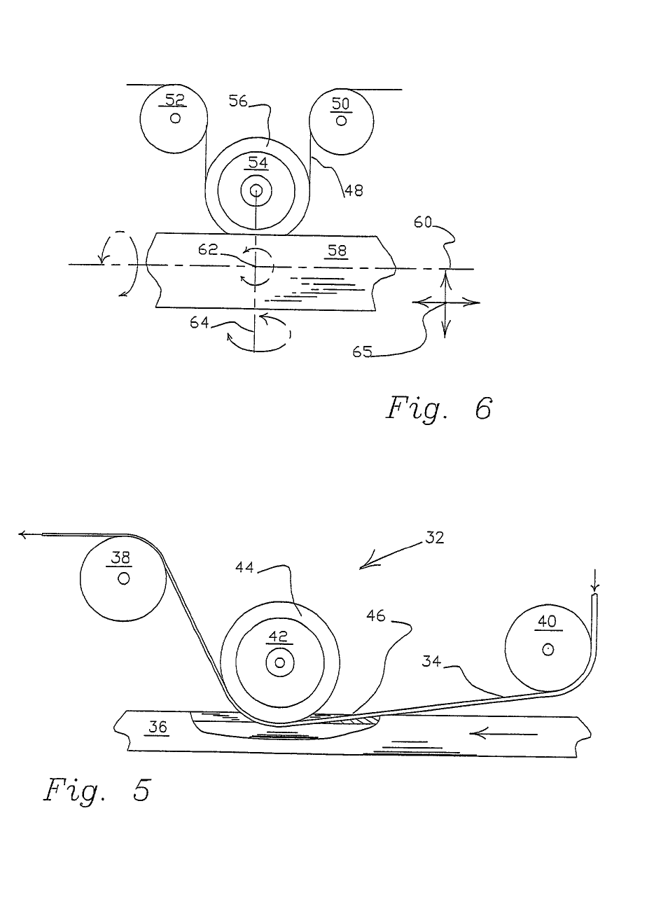

The versatility of the present invention is particularly illustrated diagrammatically in FIG. 6. A cutting wheel 54 with a peripheral track 56 and an EDM wire 48 is shown in engaged configuration with a workpiece 58. As illustrated, the workpiece can be rotated about any of its axes, 60, 62 or 64, and it can be translated laterally in a linear fashion along any of its axes, as illustrated at 65. Although it is generally preferred to move the workpiece relative to the cutting tool, if desired, it is possible to move the tool (48, 50, 52 and 54) relative to the workpiece, or both can be moved at the same time. The direction of the relative movement of the cutting tool and the workpiece is preferably parallel to the longitudinal axis of the EDM wire 48. Extreme care must be taken to avoid dislodging the wire from the relatively shallow arcuate retainer groove in which it is received when such relative motion is in some other direction. Preferably the direction of the relative movement is parallel and concurrent as illustrated, for example, in FIGS. 5 and 1. As is conventional, the reciprocal movement of the cutting wheel 54 along axis 64 is generally controlled by conventional EDM controls so that it is responsive to instantaneous changes in conditions in the cut.

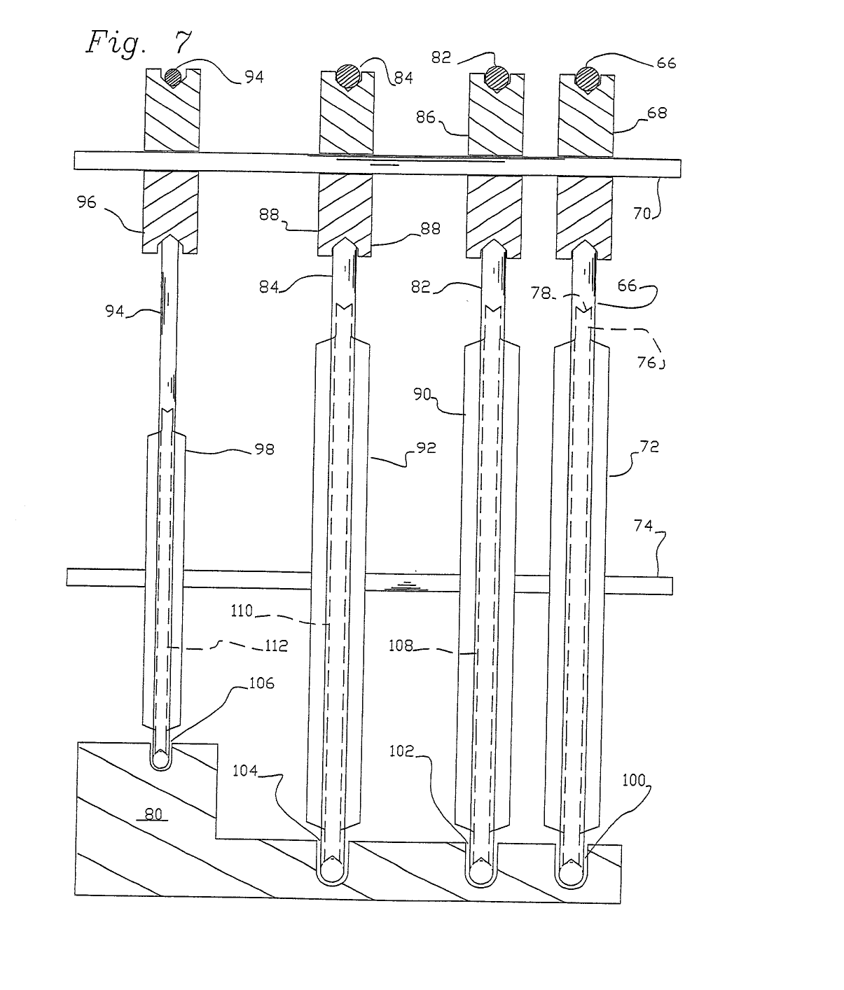

The cutting wheels according to the present invention can be ganged in series or in parallel. See, for example, the assembly that is diagrammatically illustrated in FIGS. 7 and 8. A plurality of cutting wheels 72, 90, 92 and 98 are ganged on common shaft 74 for rotation about a common longitudinal axis. Likewise, a plurality of mating guide wheels 68, 86, 88, and 96, respectively, are rotatably mounted on common shaft 70. A plurality of EDM wires 66, 82, 84 and 94, respectively, are guided by the respective guide wheels into engagement with the respective mating cutting wheels. Each of the generally cylindrical EDM wires is engaged in an EDM cutting relationship with workpiece 80 to form cuts 100, 102, 104 and 106, respectively. Each of the cutting wheels has been machined with EDM techinques to form radially extending peripheral tracks or rings 76, 108, 110, and 112, respectively. Each track is provided with an annular peripheral wire retention groove of which 78 is typical. The respective tracks can be formed, for example, by EDM machining operations, grinding operations, turning operations, or the like. Cut 106 is narrower, but not necessarily shallower, than the other cuts because EDM wire 94 is smaller in diameter than the other EDM wires. Track 112 is also thinner in the axial direction than the other tracks. Guide wheel 96 is the same size and shape as the other guides, but it serves to guide wire 94 even though wire 94 is smaller in diameter than the other wires. The generally “V” shaped configuration of the annular groove in guide wheel 96 within which wire 94 rides accommodates various diameter wires. Cutting wheel can be specially constructed to have a smaller diameter and thinner ring than the other cutting wheels, or it may simply have resulted from repeated remanufacturing of the track 112. The axial thickness of track 112 is dictated by the diameter of the wire that is used in fabricating it from a blank track. As is illustrated particularly in FIG. 8, the cutting wheels can be used in series, if desired. The length of the cutting zone is significantly extended where the cutting wheels are used in series. In the configuration illustrated in FIG. 8, FIG. 7 could have cutting wheels arrayed in both parallel and series. As will be understood by those skilled in the art, other configurations can be used. For example, the configuration shown in FIGS. 1 or 5 could be used in the parallel ganged configuration of FIG. 7. The cuts 100, 102 and 104 are illustrated as being smooth and uniform. Such cuts would be typical of the results achieved by using moderate power settings. Higher power settings, all other parameters being equal, will produce rougher cuts.

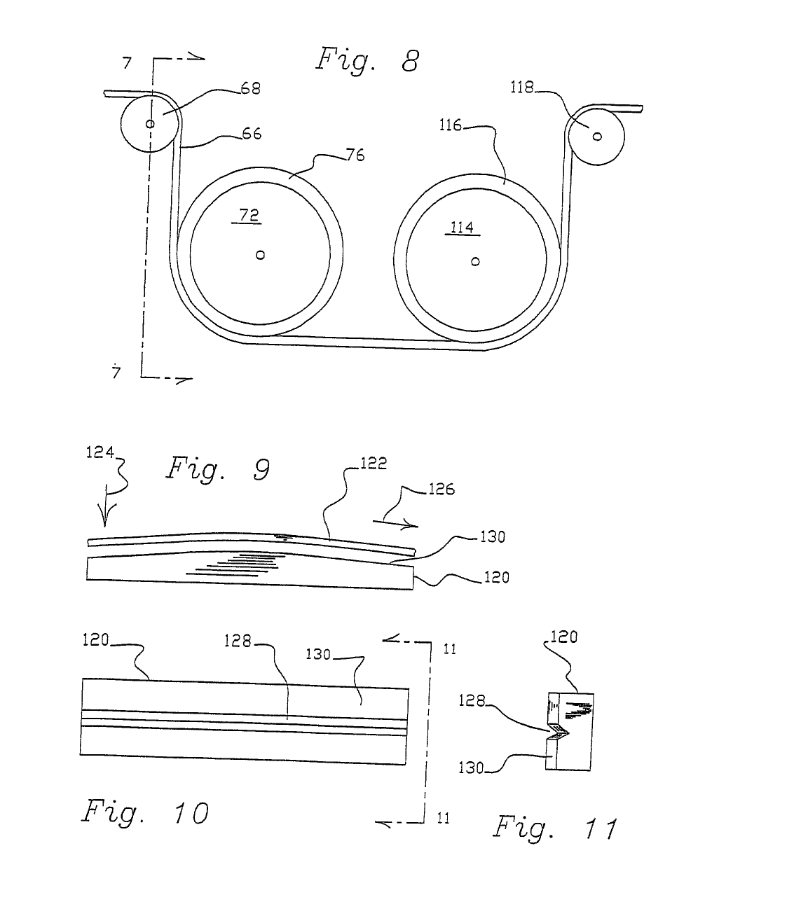

Referring particularly to FIGS. 9, 10 and 11, there is diagrammatically illustrated an EDM machining table 120 that is particularly adapted for cutting slots or grooves in elongated workpieces such as, for example, the tubular workpiece 30 that is illustrated in FIGS. 1 and 3. An elongated generally cylindrical workpiece 122 is adapted to be mounted in a “V” shaped groove 128 that extends longitudinally of the table 120. The upper surface 130 of the table 120 is formed with an arcuate convex shape so that the surface of the workpiece that is presented to the cutting wheel is under slight tension. The radius of the arcuate surface 130 as shown in FIG. 9 is shorter than is preferred in actual use. The arcuate nature of the surface 130 is exaggerated for the sake of illustration. One end of the workpiece 122 is clamped down to table 120 as shown at 124. The other end is subjected to a load as indicated at 126 so as to place workpiece 122 in tension. Preferably, the load 126 is resilient so as to accommodated changes in the length of workpiece 122 because of expansion and contraction due to temperature changes. If desired, both ends of the workpiece can be held by resilient clamps. Thus, for a long workpiece, for example, 4 feet long, that is firmly engaged with the groove 128, changes in the length of the workpiece due to changes in temperature can be better accommodated by resilient clamps that allow both ends of the workpiece to move axially against spring loads.

In a typical application of the present invention, the embodiment of FIG. 1 was employed to form a 0.010 inch wide slot in the wall of a tubular workpiece. The generally straight cylindrical workpiece had a nominal outside diameter of about 0.026 inches, a wall thickness of about 0.003 inches, and an inside diameter of about 0.020 inches. A generally cylindrical EDM wire with a diameter of about 0.008 inches was used. The tubular workpiece was composed of stainless steel. A steel cutting wheel with an outside diameter of about 1.5 inches was used. The track had an axial thickness of about 0.005 inches.

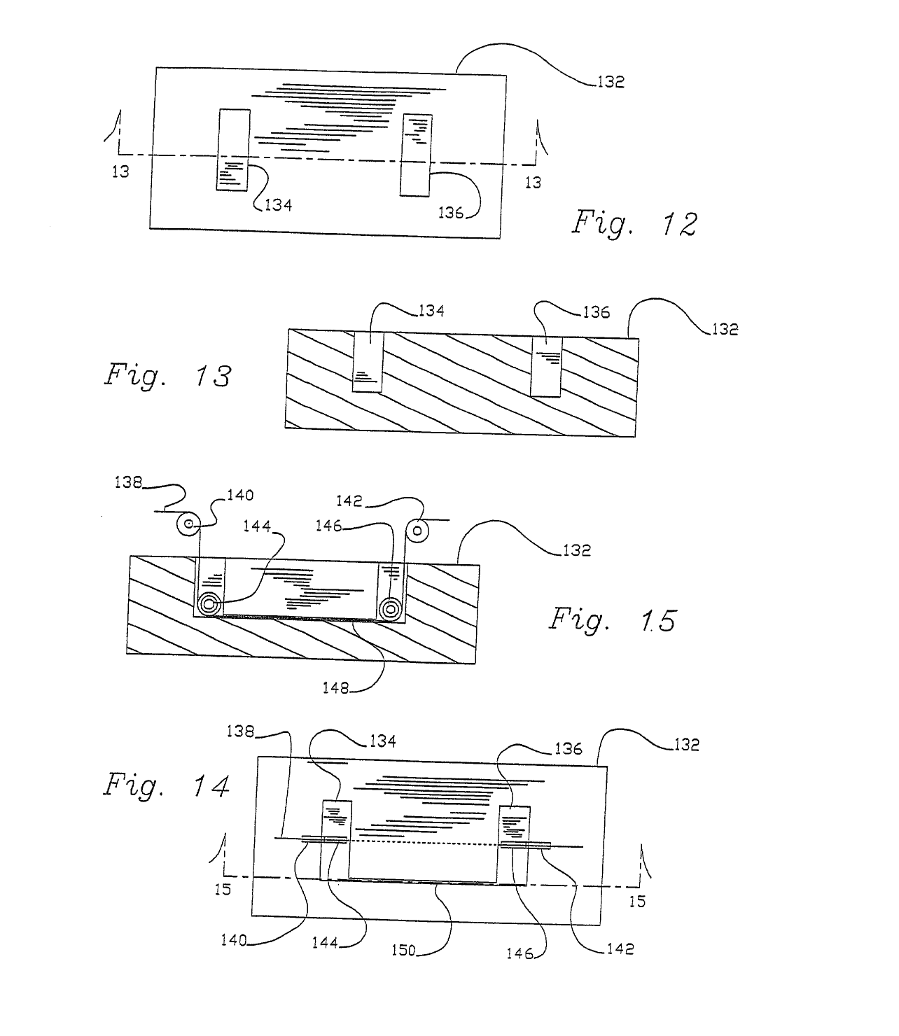

Referring particularly to FIGS. 12 through 15, a workpiece 132 is machined, for example, with conventional sinker EDM electrodes to form pockets 134 and 136. The pockets are big enough to receive the cutting wheels 144 and 146. A continuous EDM wire 138 is trained around guide rollers 140 and 142. Between Guide rollers 140 and 142, EDM wire 138 is conveyed through a cut in workpiece 132 by means of cutting wheels 144 and 146. Cutting wheels 144 and 146 are positioned in their respective pockets and moved into work piece 132 so as to form first cut 150. For sake of reference, first cut 150 is described as extending vertically, although other orientations are possible. When cutting wheels 144 and 146 reach the desired depth in workpiece 132, they are moved laterally in their respective pockets so as to form lateral cut 148, which is illustrated as extending normal to cut 150. Lateral cut 148 can extend at any angle desired so long as the configurations of the respective pockets permit the cutting wheels to move in the necessary direction. The EDM wire is typically mounted so that it extends vertically in the cutting area. For the lateral movement phase of the operation, the retention elements on cutting wheels 144 and 146 can be somewhat deeper than normal.

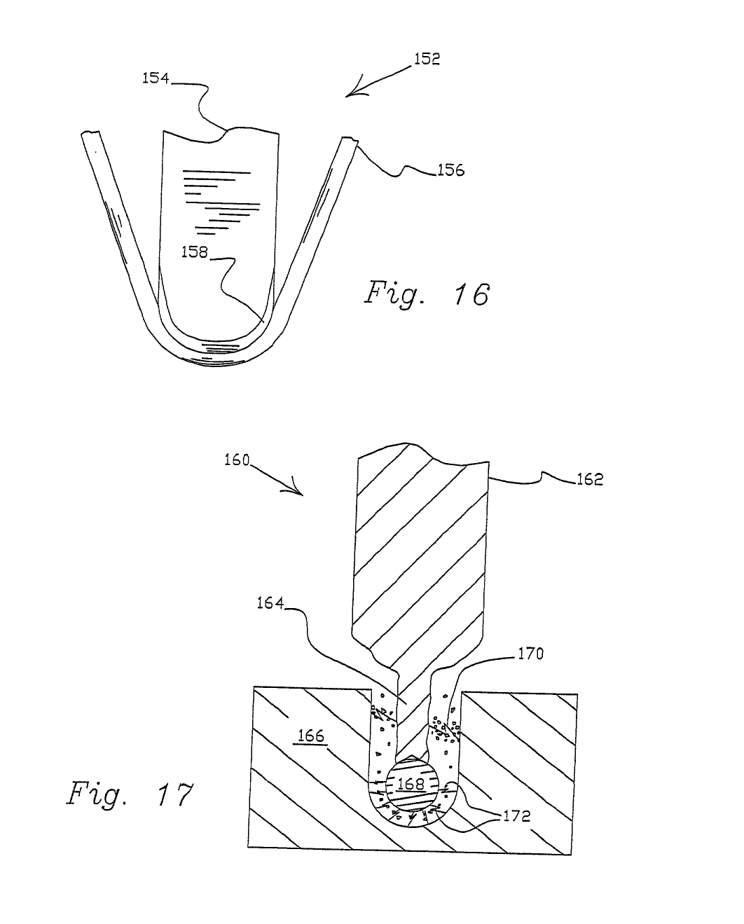

Referring particularly to FIG. 16, there is illustrated generally at 152, a stationary track or guide in the form of a guide 154 having a track or blade 158 about which an EDM wire 156 is trained. The wire guide structure in this embodiment is stationary. The materials of construction of the track and wire are selected so that the coefficient of friction between the two is low enough to permit the wire to slide over the tip of the blade while it remains in the shallow wire retention groove or retention element on the outer periphery of the track. The combination, for example, of a brass EDM wire 156 with a carbide guide 154 in dionized water permits the wire to slide freely through the groove on the track or blade 158. For the sake of consistency, the thickness of the track 158 is defined as axial thickness, and the length of the track 158 that projects outwardly from guide 154 is referred to as its radial length. The use of the term “radial” is not intended to suggest that the arc that is formed by the outer periphery of the track is necessarily a part of a perfect circle. The outer periphery of track 158 includes a shallow EDM wire retention groove or element within which wire 156 is received to a depth that is less than its radius. Wire 156 slides in this shallow groove.

Whether the track support member is fixed or rotating, the track or blade member is generally planar, with a wire retention element on its outer periphery, preferably including a longitudinally extending arcuate wire retention groove on its outer periphery. The track member has a length measured in a direction generally normal to the arcuate groove and the longitudinal axis of the wire. The track member also has a width measured lateral to the arcuate groove and generally normal to the length of the track. The aspect ratio of the track member is taken as the ratio of the length to the width.

FIG. 17 is diagrammatically illustrative of the last stage of the process by which the track member is formed by EDM machining from a thicker track support member. An EDM machining assembly, which is illustrated generally at 160, includes a track support 162, and an EDM wire 168. Track support 162 can be in the form of a rotating cutting wheel or a stationary guide member. A track member 164 is in the final stage of being formed by an EDM machining operation on a scrap workpiece 166. During EDM machining, as is conventional, an electrical potential is established between a workpiece and a continuous wire electrode. A spark is generated between the electrode and the workpiece. The electrical spark causes the erosion that cuts the workpiece. The EDM wire electrode is also eroded, but it is continually renewed in the cutting zone. Typical sparks between the wire 168 and the bottom of the cut are illustrated at 172. Because, as shown, there is electrically conductive debris in the cut, there is occasionally a spark between the respective opposed side walls of the track 164 and the workpiece 166. A typical such spark is illustrated at 170. Sparks, of which 170 is typical, serve to erode the thickness of the track until it is thinner than the diameter of wire 168. Such erosion occurs even though the gaps between the walls of the cut and the walls of the track are greater than gap between the wire and the walls of the cut because debris collects in one area to the extent that a conductive path is formed between the cut and the track. Such erosion of the side walls of the track 164 tends to occur when the parameters of the EDM operation are such that a particularly strong sparks is generated. During its intended use, the spark is generally not as strong as it is while forming the track, so there is little or no erosion of the side walls of the track during the normal use of the assembly. The irregular nature of the side walls of the track 164 produced by EDM machining is over emphasized in FIG. 17, for purposes of illustration. As is well known, the roughness of an EDM produced cut is generally proportional to the strength of the spark. That is, the stronger the spark, the rougher and quicker the cut. The EDM assembly comprising wire 168 and track support 162 can cut workpiece 166 to a depth that is slightly less than that where a spark would form between the enlarged base of track 164 and the upper surface of the workpiece 166.

FIGS. 18 and 19 illustrate the beginning and end stages in the EDM machining of a blank track support 174 to form a track such as that shown at 164 in FIG. 17. An EDM wire is trained in peripheral groove 176 and a spark is established between the blank track support 174 and a scrap workpiece. EDM wire 178 is continually replenished, but the blank 174 remains continually exposed to the cutting spark. As a result, the radially extending opposed sides of the blank 174 are eroded away as shown at 182 and 180 until a track or blade having the desired thickness is achieved.

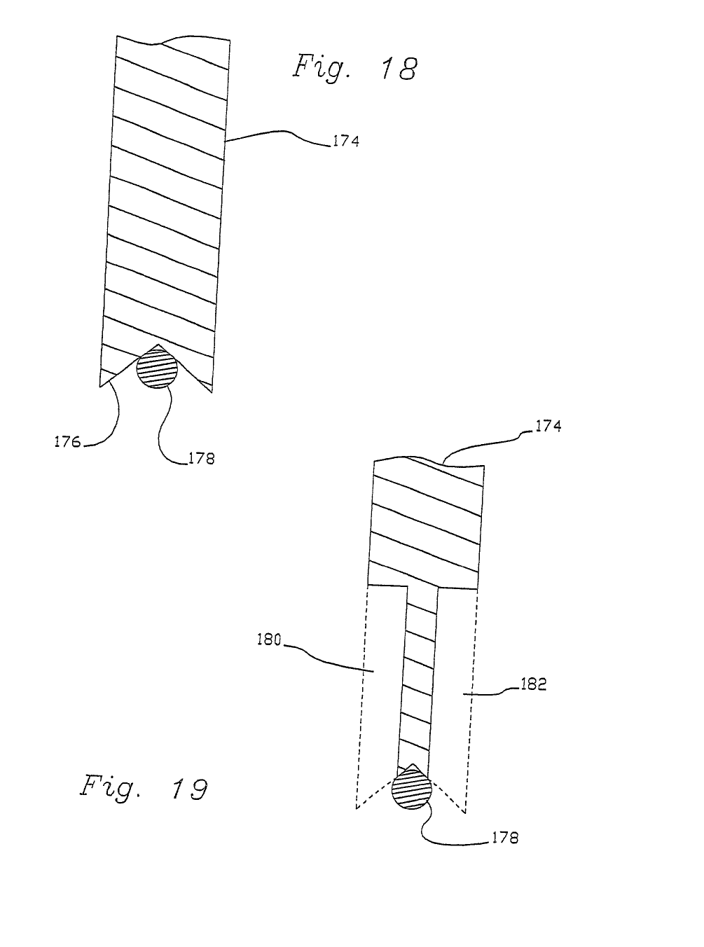

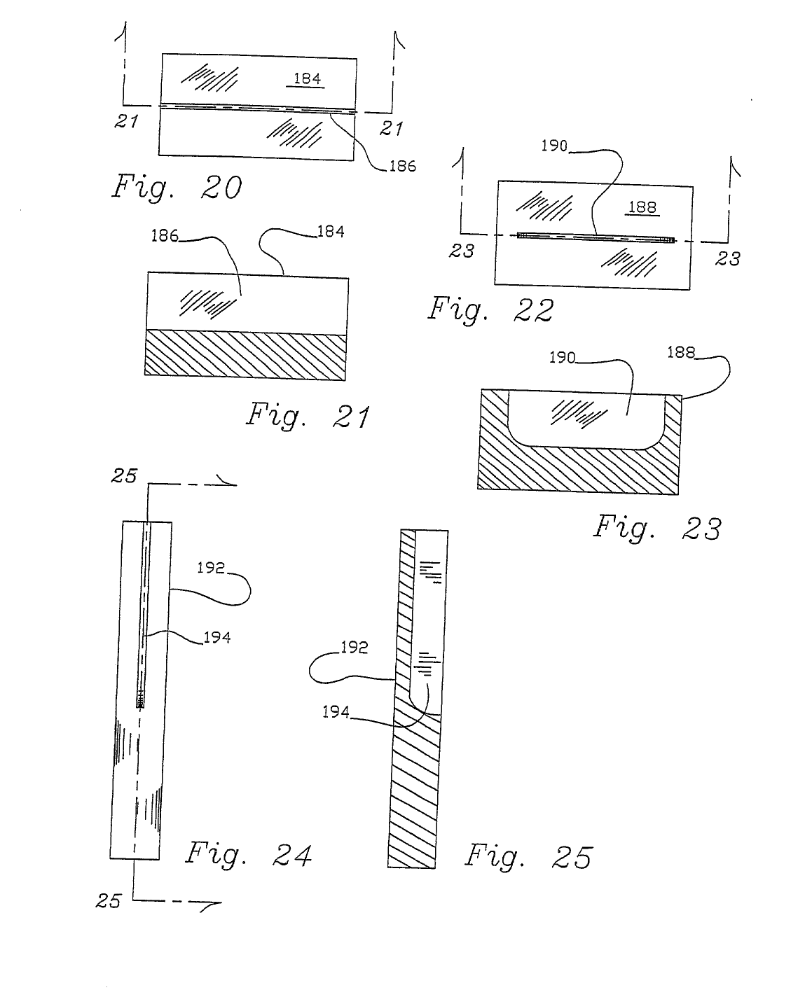

FIGS. 20 and 21 illustrate an open hole in the form of slot 186 formed in a workpiece 184. Slot 186 can be formed by conventional EDM procedures where a continuous EDM wire extends completely across and beyond the edges of the workpiece 184. Open slot 186 can also be formed one short blind segment at a time where the continuous EDM wire is carried into the slot 186 in a wire retaining groove on the periphery of a track support that has a track with an axial width that is less than the diameter of the EDM wire. Where slot 186 is relatively long compared to its width, for example, 4 feet long by 0.010 inches wide, the only practical way to form it is one short blind segment at a time.

FIGS. 22 and 23 illustrate a workpiece 188 in which a blind hole in the form of blind slot 190 has been formed using a continuous EDM wire assembly according to the present invention. Blind slot 190 can not be formed by an EDM wire extending entirely across workpiece 188. Because the erosion of a fixed (sinker) EDM electrode changes its dimensions during the cut, it would generally be impossible to hold the dimensions and finish of the blind slot 190 to close tolerances with a sinker elctrode. For example, a blade sinker electrode in a dionized water bath would quickly erode. Because the EDM wire is continuously renewed as the cut proceeds, it is possible to hold the dimensions of the cut to close tolerances while using a deionized water bath, which greatly accelerates the cutting process.

FIGS. 24 and 25 illustrate the formation of a blind hole in the form of blind slot 194 in a cylindrical workpiece 192. Blind slot 194 is formed by a continuous EDM wire that is carried into the slot on the arcuate outer periphery of a track or blade. The track has a width that is less than the diameter of the EDM wire, and an aspect ratio of more than about 2 to 1 (radial length to axial width).

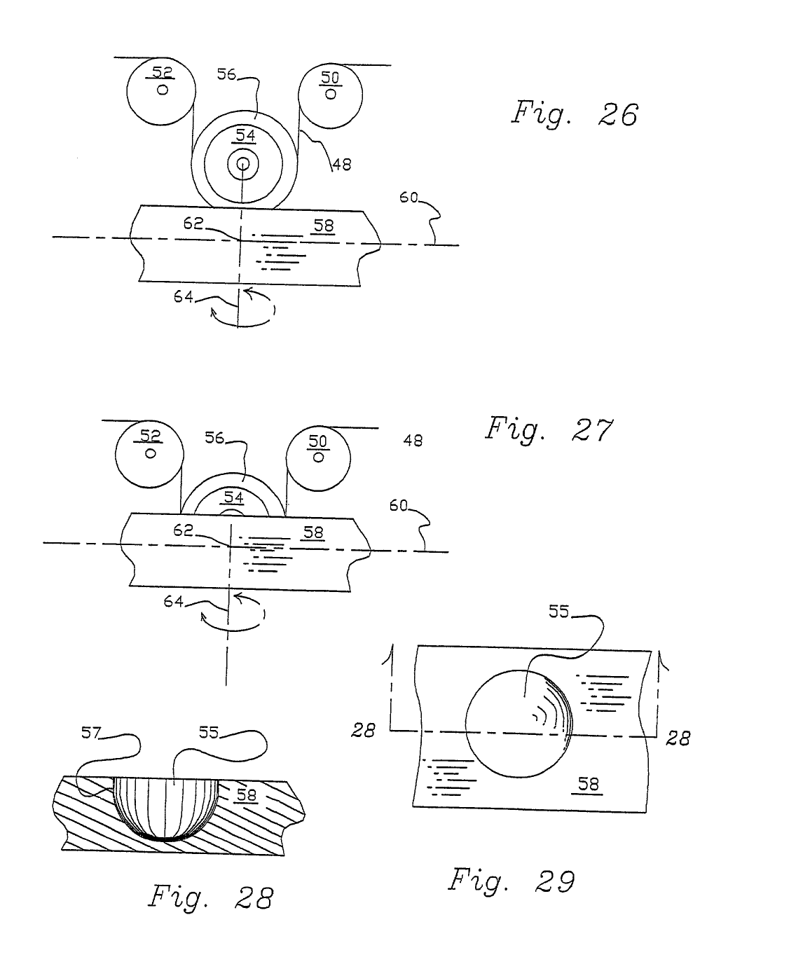

FIGS. 26 through 29 illustrate diagrammatically the use of an EDM assembly which includes cutting wheel 54, track 56 and EDM wire 48 to form a cylindrical hole or bore 55 in a workpiece 58. The use of a track to carry an EDM wire into a workpiece while rotating the workpiece about an axes that extends generally normal to the longitudinal axes of the EDM wire in the cutting zone erodes the workpiece in a pattern that is dictated by the relationship between the positions of the axes of rotation of the workpiece and the cutting zone. For example, offsetting the two results in the formation of a ring in the workpiece. As shown in FIGS. 27 and 28, the track 56 on cutting wheel 54 has carried the EDM wire 48 into the workpiece to such a depth that cylindrical wall 57 has formed in the bore 55. Often the wire retention grooves that carry the EDM wire are somewhat deeper and the tracks are closer in width to the diameter of the wire than is the case where the direction of the cut is in axial alignment with the longitudinal axes of the EDM wire. A typical hole boring EDM assembly comprises a circular cutting wheel that is about 1.086 inches in diameter, and an EDM wire that is about 0.008 inches in diameter. Generally, the power settings are such that a spark gap of about 0.002 inches is formed. This EDM assembly forms a bore with a diameter of about 1.100 inches.

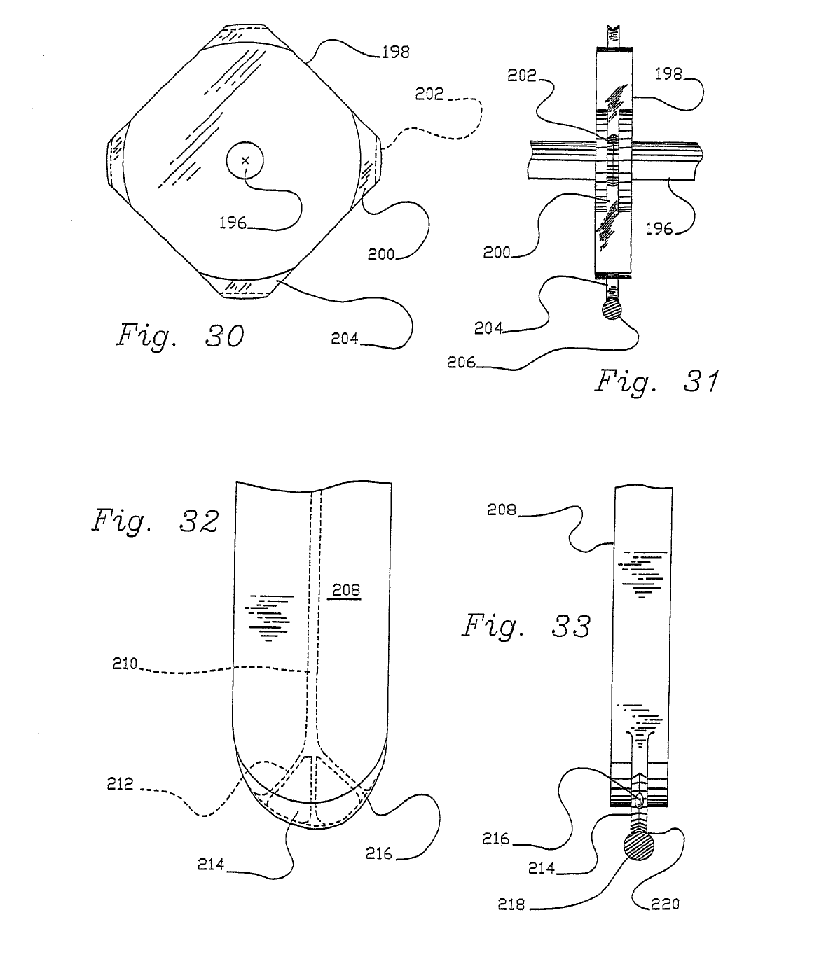

FIGS. 30 and 31 diagrammatically illustrate the use of a rotatable track support in the form of a square cutting wheel 198. The EDM wire, shown in cross-section at 206 in FIG. 31, is trained around the rounded corners of wheel 198 in shallow wire retention grooves of which 202 is typical. Each of the corners of the wheel 198 is provided with an arcuate track or blade of which 200 and 204 are typical. In this configuration the groove and the track are discontinuous. Wheel 198 is mounted for rotation about axle 196. Wheel 198 can be used in at least two different ways. The wheel 198 can be held stationary with EDM wire 206 being drawn through the shallow groove on, for example, track 204. When track 204 becomes worn or damaged, wheel 198 is conveniently rotated one-quarter of a turn to present track 202 in position to carry EDM wire 206 into the cut. Alternatively, wheel 198 can be rotated either continuously or intermittently to carry EDM wire 206 into the cut.

FIGS. 32 and 33 illustrate the use of a hydrostatic bearing for EDM wire 218 on track or blade 214 of stationary track support 208. A fluid gallery 210 is provided within stationary blade 208. Fluid gallery 208 includes branches, a typical one of which is illustrated at 212. The branches terminate in discharge ports, a typical one of which is illustrated at 216. A pressurized lubricating fluid is supplied to gallery 210, and is injected into the wire retention element on the radially outer periphery of the track 214 through the outlet ports. The lubricating fluid acts at the interface 220 between the EDM wire 218 and the track 214 to facilitate the movement of the EDM wire 218 as it slide longitudinally through the shallow wire retention groove. Such lubrication minimizes wear on the track and also generally permits the use of sharper bends in the EDM wire.

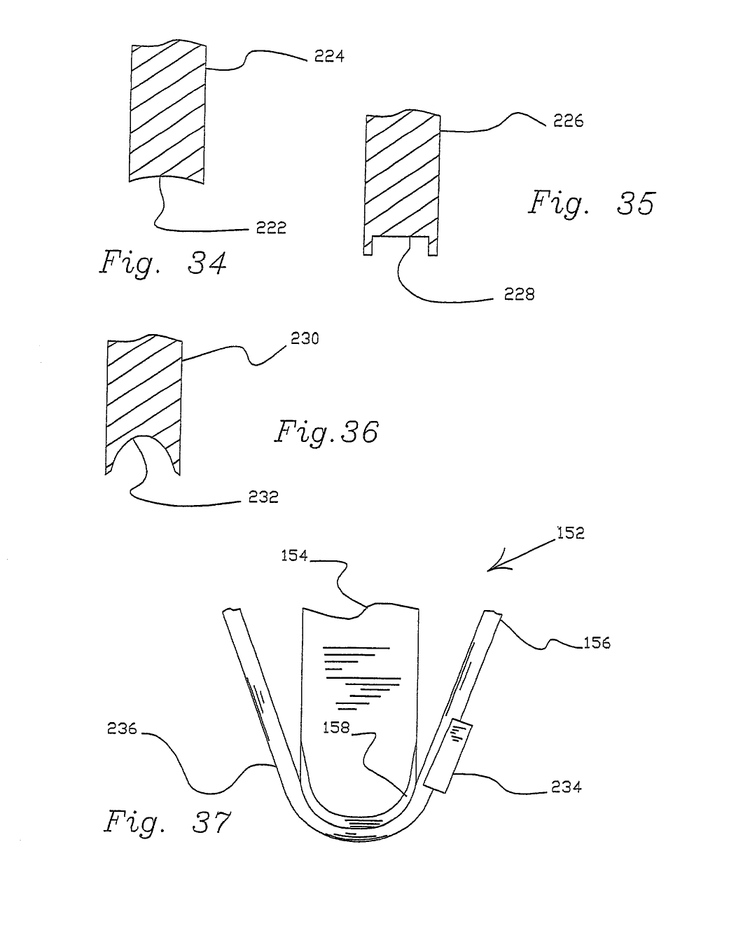

FIGS. 34, 35 and 36 illustrate the configurations of a few of the possible EDM wire holding structures. The configuration of the wire holding structure is preferably concave so as to confine the wire. The finish of the wire holding structure also has an impact on the retentive nature of the structure. A rough abrasive surface tends to hold the wire so as to prevent it from slipping off of the track member. Under certain circumstances, particularly where the wire retention element includes external guides and the track support member is rotatable, a flat abrasive surface can be sufficient to hold the wire in place on the track member. In FIG. 34, the track member 224 is provided with a very shallow circular wire holding structure 222. The wire holding structure 228 of track member 226 in FIG. 35 is a flat bottomed structure with side rails to hold the wire on the track. Parabolic wire holding structure 232 on the outer periphery of track 230 in FIG. 36 serves to illustrate a further embodiment of the wire holding structure.

The retention elements, in addition to the wire holding structure, can also include mechanical wire guides positioned just outside of the cutting zone on one or both sides of the cutting zone. For example, the guide rollers 18 and 20 in FIG. 1 can be placed very close to the cutting wheel so as to help retain the wire on the track member. Other forms of guides, from rings to open grooves, and the like, can be used to help retain the wire on the track member. See, for example, FIG. 37, which is similar to FIG. 16 and includes a wire guide 234. Wire guide 234 comprises a part of the wire retention element, which illustrated in FIG. 37. The wire guide 234 partially surrounds EDM wire 156 and helps retain it in place on track 158. A second wire guide can be provided at 236 on the other side of the cutting zone, if desired. The wire guides are preferably positioned so that they are just clear of the workpiece. This provides the maximum retentive support for the EDM wire in the cutting zone.

The EDM wire that is employed in practicing the invention is preferably generally cylindrical in form with a generally circular cross-section. Other forms can be employed, if desired. For example, diamond or square cross-sections can be employed. For the sake of consistency, the cross-sectional thicknesses of such wires are described as their “diameters”. Electrically conductive wires are capable of serving, and, according to the present invention, are described as EDM wires whether they are specially manufactured for this purpose or not.

The methods and apparatus of the present invention are applicable to a wide variety of EDM continuous wire operations where conventional or special operating parameters, equipment, and setups are employed.

What have been described are preferred embodiments in which modifications and changes may be made without departing from the spirit and scope of the accompanying claims. Clearly, many modifications and variations of the present invention are possible in light of the above teachings. It is therefore to be understood that, within the scope of the appended claims, the invention may be practiced otherwise than as specifically described.

What is claimed is:

1. An EDM machine assembly that is adapted to employ a continuous EDM wire, said continuous EDM wire having a diameter and a radius, said EDM machine assembly being adapted to advance said continuous EDM wire, said EDM machine assembly comprising a track support member, said track support member including a generally planar track element extending from an outer periphery thereof, said track element including a wire retention element formed in an outer periphery thereof, said wire retention element including a generally arcuate wire retaining groove on the outer periphery of said track element, said track element having a width less than said diameter, said wire retaining groove being adapted to receive said continuous EDM wire to a depth of less than said radius.

2. An EDM machine assembly of claim 1 wherein said track support member comprises a rotatably mounted generally circular cutting wheel.

3. An EDM machine assembly of claim 1 wherein said track support member comprises a stationary guide member, and said continuous EDM wire is adapted to being slidably received in said wire retaining groove.

4. An EDM machine assembly of claim 1 wherein said track element is composed of non-conductive material.

5. An EDM machine assembly of claim 1 wherein said track element is composed of conductive material.

6. An EDM machine assembly of claim 1 wherein said track element has an aspect ration of at least about 2 to 1.

7. A track support member for a continuous EDM wire in an EDM machine assembly, said continuous EDM wire having a diameter, said track support member comprising a circular wheel including a radially outer periphery and a track element projecting radially outwardly from said radially outer periphery, said track element having a thickness of less than said diameter and including an EDM wire retaining element, said EDM wire retaining element being adapted to retain said EDM wire on said track element.

8. A track support member for a continuous EDM wire in an EDM machine assembly according to claim 7 wherein said track element has an aspect ratio of at least about 2 to 1.

9. A method of forming a guide for a continuous wire EDM machine comprising:
selecting a continuous EDM wire having a diameter and a longitudinal axis;
selecting a scrap electrically conductive workpiece;
selecting an electrically conductive blank cutting wheel, said blank cutting wheel being mounted for rotation about a rotational axis, said blank cutting wheel having radially extending opposed sides, an annular periphery, and an annular wire retention groove circumscribing said annular periphery, said annular wire retention groove being generally concentric with said rotational axis and said blank cutting wheel having an axial thickness greater than said diameter;
training said continuous EDM wire part way around said annular periphery in said annular wire retention groove to form an assembly where said EDM wire is engaged in said annular wire retention groove;
establishing an electrical potential between said assembly and said workpiece;
advancing said assembly and said workpiece relatively towards one another until an electrical spark is established between said workpiece and said assembly to thereby establish a cutting zone;
moving said cutting zone relative to said workpiece and rotating said blank cutting wheel so that the entire said annular periphery moves through said cutting zone;
allowing said spark to erode said radially extending opposed sides until said axial thickness is less than said diameter.

10. A method of forming a guide for a continuous wire EDM machine comprising:
selecting a continuous EDM wire having a diameter;
selecting a scrap electrically conductive workpiece;
selecting an electrically conductive blank cutting blade, said blank cutting blade having radially extending opposed side walls, a generally arcuate periphery, and a wire retention groove circumscribing said arcuate periphery, said blank cutting blade having an axial thickness adjacent said wire retention groove greater than said diameter;
training said continuous EDM wire at least part way around said arcuate periphery in said wire retention groove to form a cutting zone wherein said EDM wire is engaged in said wire retention groove;
applying a current to said continuous EDM wire and advancing said cutting zone toward said workpiece until a spark is established between said workpiece and said cutting zone, and allowing said spark to erode said radially extending opposed side walls adjacent to said wire retention groove;
moving said continunous EDM wire through said cutting zone; and
allowing said spark to erode said radially extending opposed side walls until said axial thickness is less than said diameter.

11. A process of using a continuous wire EDM machine assembly to form a blind hole in a workpiece comprising:
selecting a continuous EDM wire, said continuous EDM wire having a diameter, a radius, and a longitudinal axis;
selecting a track support member, said track support member being adapted to guide said EDM wire, said continuous EDM wire, said track support member including a peripheral track element bounded at its outer periphery by a wire retention groove, said wire retention groove having a longitudinal axis, said peripheral track element having a width in a direction generally normal to the longitudinal axis of the wire retention groove that is less than said diameter, and an aspect ratio of at least about 2 to 1;
mounting said continuous EDM wire for movement along its longitudinal axis in said wire retention groove;
establishing an electrical potential between said workpiece and said continuous EDM wire;
advancing said workpiece and said continuous EDM wire relatively towards one another until a spark forms between said workpiece and said continuous EDM wire, and allowing said spark to erode said workpiece while continually refreshing said continuous EDM wire by advancing said continuous EDM wire along its longitudinal axis; and
continuing said advancing and allowing said spark to erode said workpiece to form said blind hole in said workpiece to a depth greater than about said radius.

12. A process of using a continuous wire EDM machine assembly to form a blind hole in a workpiece according to claim 11 wherein said track support member comprises a fixed guide member and said continuous EDM wire is adapted to slide through said wire retention groove.

13. A process of using a continuous wire EDM machine assembly to form a blind hole in a workpiece according to claim 11 wherein said track support member comprises a rotatable track support member.

14. A process of using a continuous wire EDM machine assembly to form a blind hole in a workpiece according to claim 11 including selecting a peripheral track element having an aspect ratio greater than about 5 to 1.

15. A process of using a continuous wire EDM machine assembly to form a blind hole in a workpiece according to claim 11 including continuing said advancing and allowing said spark to erode said workpiece to form said blind hole in said workpiece to a depth greater than about said diameter.

16. A process of using a continuous wire EDM machine assembly to form a blind hole in a workpiece according to claim 11 including continuing said advancing and allowing said spark to erode said workpiece to form said blind hole in said workpiece to a depth greater than about twice said diameter.

17. A process of using a continuous wire EDM machine assembly to form a blind hole in a workpiece according to claim 11 including selecting a tubular workpiece.

18. A process of using a continuous wire EDM machine assembly to form a blind hole in a workpiece according to claim 11 including selecting a tubular workpiece, and continuing said advancing to form a longitudinally extending slot in a wall of said tubular workpiece.

19. A process of using a continuous wire EDM machine assembly to form a blind hole in a workpiece according to claim 11 including selecting a solid workpiece.

20. A process of forming a blind hole in a workpiece comprising:
selecting a track support member having a track element, said track element having a length, a width, and a wire retaining element including an arcuate wire holding structure extending longitudinally on an outer periphery thereof, said length extending generally normal to said arcuate wire holding structure, said width extending generally normal to said length, and said length being at least twice said width;
selecting a continuous EDM wire having a diameter and a longitudinal axis;
positioning said continuous EDM wire on said arcuate wire holding structure, said width being less than said diameter;
establishing an electrical potential between said workpiece and said continuous EDM wire;
bringing said continuous EDM wire adjacent to said workpiece, and allowing a spark to form between said workpiece and said continuous EDM wire;
allowing said spark to erode said workpiece; and
moving said workpiece and said track support member relative to one another to advance said wire retaining element into said workpiece to form a blind hole.

21. A process of forming a blind hole in a workpiece comprising:
selecting a continuous EDM wire element, said continuous EDM wire element having a diameter, a radius, and a longitudinal axis;
selecting a wire guide structure, said wire guide structure being adapted to retain said continuous EDM wire element on an outer peripheral edge thereof, said wire guide structure adjacent said outer peripheral edge having a thickness that is less than said diameter, said wire guide structure adjacent said outer peripheral edge having a radial length in a direction generally normal to said longitudinal axis;
mounting said continuous EDM wire element on said outer peripheral edge to form an EDM assembly wherein said continuous EDM wire element projects outwardly from said wire guide structure;
selecting a workpiece;
establishing an electrical potential between said workpiece and said EDM assembly;
positioning said workpiece in operative association with said EDM assembly and allowing a spark to form between said continuous EDM wire element and said workpiece to form a cutting zone;
advancing said EDM wire element into said workpiece in said cutting zone to a depth at least equal to about said radius; and
renewing said EDM wire element in said cutting zone.

22. An EDM wire assembly comprising:
a wire guide structure, said wire guide structure being adapted to retain a continuous EDM wire element on an outer peripheral edge thereof during an EDM cutting operation, said continuous EDM wire element having a longitudinal axis, a diameter and a radius, said wire guide structure adjacent said outer peripheral edge having a thickness that is less than said diameter, and a radial length that is at least about equal to said radius.

23. Method of making an EDM wire assembly comprising:
forming a wire guide structure, said wire guide structure being adapted to retain a continuous EDM wire element on an outer peripheral edge thereof during an EDM cutting operation, said continuous EDM wire element having a longitudinal axis, a diameter and a radius, said wire guide structure adjacent said outer peripheral edge having a thickness that is less than said diameter, and a radial length that is at least about equal to said radius.

24. Method of making a blind hole using an EDM wire assembly comprising:
selecting a wire guide structure and a continuous EDM wire element, said wire guide structure being adapted to retain said continuous EDM wire element on an outer peripheral edge thereof during an EDM cutting operation, said continuous EDM wire element having a longitudinal axis, a diameter and a radius, said wire guide structure having a thickness adjacent said outer peripheral edge that is less than said diameter, and a radial length that is at least about equal to said radius, said continuous EDM wire element being mounted on said outer peripheral edge to form said EDM wire assembly;
establishing an electrical spark between a workpiece and said continuous EDM wire element, and allowing said electrical spark to erode said workpiece to form said blind hole; and
advancing said EDM wire assembly into said workpiece to a depth at least about equal to said radius.
